(19) United States
(12) Patent Application Publication
(10) Pub. No.: US 2026/0210443 A1
(43) Pub. Date: Jul. 23, 2026

(54) SHUT-OFF DEVICE WITH VARIABLE STOP

(71) Applicant: Neoperl GmbH, Mullheim (DE)

(72) Inventor: Marc TEMPEL, Freiburg (DE)

(73) Assignee: Neoperl GmbH, Mullheim (DE)

(21) Appl. No.: 19/456,374

(22) Filed: Jan. 22, 2026

(30) Foreign Application Priority Data
Jan. 23, 2025 (EP) 25153590.2

(51) Int. Cl. F16K 1/52; F16K 31/00

(52) U.S. Cl. CPC F16K 1/523; F16K 31/003

(57) ABSTRACT

A shut-off device (1), in particular a valve, for a flowable medium, having at least one closure element (3) that can be moved into an open position and a closed position. In the open position a flow rate of the flowable medium through the shut-off device can be adjusted. The shut-off device allows an easy selection of flow rates that can be adjusted when the shut-off device is in the open state. The shut-off device (1) has at least one variable stop (36), in particular at least one variably arrangeable stop (36), and at least one counter-stop (37) cooperating therewith, and using the at least one stop (36) and the at least one counter-stop (37) the flow rate that is adjustable in the open position can be limited to a variable subset.

### DESCRIPTION

### CROSS-REFERENCE TO RELATED APPLICATIONS

This application claims priority from European Patent Application No. 25153590.2, filed January 23, 2025, which is incorporated herein by reference as if fully set forth.

### TECHNICAL FIELD

The invention relates to a shut-off device for a flowable medium, having at least one closure element that can be moved into an open position and a closed position, wherein in the open position a flow rate of the flowable medium through the shut-off device can be adjusted. The shut-off device can be a valve in particular.

### BACKGROUND

Shut-off devices are generally known from practice, for example in the form of valves, slide valves, flaps, or taps. Shut-off devices regularly have an inlet, an outlet, a closure element, and a seat for the closure element.

A shut-off device serves to release, stop and/or throttle the flow of a flowable medium, in particular the flow of a fluid from the inlet to the outlet, through an opening adjacent to the seat of the shut-off device. For this purpose, a shut-off device can be brought into different states.

In a closed state of a shut-off device, in particular a valve, in which no flow of a flowable medium through the opening adjacent to the seat of the shut-off device is possible, the closure element is arranged in the closed position. In the closed position, the closure element is arranged in such a way that it seals the seat so that a flowable medium cannot or essentially cannot flow through the opening adjacent to the seat of the shut-off device.

In an open state of a shut-off device, in particular a valve, in which a flow of a flowable medium through the opening adjacent to the seat of the shut-off device is possible, the closure element is arranged in the open position. In the open position, the closure element can, for example, be arranged at a distance from the seat so that a flowable medium can flow through the opening adjacent to the seat of the shut-off device.

Shut-off devices are also known in which the flow rate of the flowable medium through the shut-off device can be adjusted when the device is open. For example, in slide valves, the closure element designed as a slide valve can be displaced to varying degrees in relation to the seat. In butterfly valves, for example, the closure element designed as a butterfly can be set at different angles in relation to the seat. In valves, the closure element can be positioned at different distances from the seat.

It has been shown that it may be desirable for a user of shut-off devices to be able to adjust predetermined flow rates and/or ranges of flow rates more easily.

### SUMMARY

The invention is based on the object of providing a shut-off device that allows easy selection of flow rates that can be set when the shut-off device is open.

This object is solved by the subject matter and features disclosed herein. Advantageous designs are described below and in the claims.

The features listed individually in the description and claims can be combined with each other in any technologically sensible way and define further designs of the invention. Further preferred designs of the invention are also presented.

To solve the object, the invention proposes that a shut-off device of the type mentioned at the outset should have at least one variable stop and at least one counter-stop that works with it, by means of which the flow rate adjustable in the open position can be limited to a variable subset.

The at least one variable stop can be variable in particular in that the at least one variable stop can be arranged variably.

In other words, in a shut-off device of the type mentioned at the outset, the at least one variable stop described here can be arranged in such a way that, when the closure element is in the open position, it is no longer possible to set all the flow rates that can in principle be set with the shut-off device. This means that settings of the shut-off device that are not regularly used by a user of the shut-off device and/or settings of a sanitary unit comprising the shut-off device that are not regularly used by a user of the shut-off device can be excluded from use. This can make the use of the shut-off device and/or the sanitary unit more intuitive and/or easier for the user. In particular, the at least one variable stop can be arranged in different positions and/or orientations.

The interaction between the at least one variable stop and the at least one counter-stop can be a mechanical interaction, in particular further in the form of physical contact between the at least one variable stop and the at least one counter-stop. For example, the interaction may be a mechanical interaction, in particular in the form of physical contact, between one of the at least one variable stop and one of the at least one counter-stop.

The at least one variable stop and the at least one counter-stop may in particular be designed in such a way that they interact with each other in a direction oriented transversely and preferably orthogonally to a direction of movement of the closure element. In addition or alternatively, the at least one variable stop and the at least one counter-stop may interact with each other in a direction of rotation oriented around the direction of movement of the closure element.

In practice, it may additionally or alternatively be provided that the closure element can be arranged in the open position in a plurality of opening positions, wherein each opening position defines a predetermined flow rate of the flowable medium through the shut-off device, wherein the at least one variable stop and the at least one counter-stop can be used to limit the plurality of opening positions to a variable subset of this plurality.

In other words, the at least one variable stop can be arranged so that the closure element in the open position can no longer be positioned in all of the opening positions of the plurality of opening positions. This allows the aforementioned settings of the shut-off device and/or the sanitary unit, which a user does not regularly use, to be excluded in a manner that is particularly intuitive for the user and/or technically robust. Due to this design of the shut-off device, switching the closure element between the open position and the closed position and adjusting the flow rate through the shut-off device in the open position can be done exclusively with the closure element. This shut-off device is therefore particularly simple and robust. At the same time, the at least one variable stop and the at least one counter-stop make it easy to achieve the described, achievable benefits.

In practice, it may additionally or alternatively be provided that the at least one variable stop can be variably arranged in relation to a maximum opening position, which defines a maximum flow rate of the flowable medium through the shut-off device. In addition or alternatively, it may be provided that the at least one variable stop can be variably arranged in relation to a minimum opening position, which defines a minimum flow rate of the flowable medium through the shut-off device.

In particular, due to a variable arrangement of the at least one variable stop in relation to the minimum opening position and/or the maximum opening position, it may be possible to exclude an arrangement of the closure element in a range of opening positions that includes the minimum opening position. Similarly, due to a variable arrangement of the at least one variable stop in relation to the minimum opening position and/or the maximum opening position, it may be possible to exclude an arrangement of the closure element in a set of opening positions that includes the maximum opening position. In other words, it may be possible to exclude the extrema, i.e., the maximum possible flow and/or the minimum possible flow, from the setting by a user.

In this context, it may be particularly advantageous if the plurality of opening positions in which the closure element can be arranged is limited to a subset of this plurality and the subset comprises a plurality of opening positions that transition smoothly into one another. If the lowest possible flow rate is excluded, the user can, for example, adjust an actuator of the shut-off device, in particular continuously, until the at least one variable stop contacts the at least one counter-stop, in particular until one of the at least one variable stop and one of the at least one counter-stop come into contact with each other, and thus set a minimum flow rate that can be achieved with this predetermined arrangement due to the previously selected arrangement of the at least one variable stop. This makes it possible to set the lowest possible flow rate through the shut-off device particularly accurately and easily.

If the maximum possible flow rate is excluded, the user can, for example, adjust an actuator of the shut-off device, in particular continuously, until the at least one variable stop contacts the at least one counter-stop, in particular until one of the at least one variable stop and one of the at least one counter-stop come into contact with each other, and thus achieves a maximum flow rate that can be achieved with this predetermined arrangement due to the previously selected arrangement of the at least one variable stop. This makes it possible to reliably prevent particularly large flow rates through the shut-off device. Especially if the shut-off device is installed in a sanitary unit, for example, water can thus be saved in a simple manner.

In practice, it may additionally or alternatively be provided that the closure element can be arranged in the open position in a stop position that is coupled to an arrangement of the at least one variable stop.

The stop position is one of a plurality of opening positions. The stop position can in particular be a position at one end of a series of opening positions of the subset of the plurality of opening positions of the closure element described here. The arrangement of the closure element in the stop position can in particular be uniquely and/or mechanically coupled to an arrangement of the at least one variable stop. A unique coupling means that the at least one variable stop can be arranged in a plurality of positions and/or orientations, in particular with respect to the minimum opening position and/or the maximum opening position, wherein each position and/or each orientation of the at least one variable stop is uniquely coupled, i.e. in a single manner, to an opening position of the closure element when the at least one variable stop interacts with the at least one counter-stop, in particular is in contact with it.

In practice, it may additionally or alternatively be provided that the at least one closure element is a closure element that can be switched discretely between the open position and the closed position, in particular with a bistable actuating mechanism.

The closure element or a component of the closure element can be brought discretely into two different distances from the seat of the closure element, in particular with the bistable actuating mechanism. A discretely switchable closure element refers to a closure element that can be switched abruptly and/or that can be switched without assuming a stable intermediate position between the open position and the closed position.

This allows for easy operation and easy switching between positions, as a user only has to press to achieve the switch. To switch the closure element with the bistable actuating mechanism, the shut-off device and/or the actuating mechanism may in particular have an actuating means which is designed in particular as a manual operating element and which can be operated by a user.

In practice, it may additionally or alternatively be provided that the shut-off device has an adjustment device with which the at least one closure element can be arranged in a plurality of opening positions.

In other words, the shut-off device may have the adjustment device, which serves to move the closure element to a variably adjustable, stable distance from the seat.

By means of the adjustment device, a flow rate of the flowable medium through the opening adjacent to the seat can be adjusted by adjusting the distance of the closure element or a component of the closure element to the seat of the closure element. In particular, the closure element can be continuously adjustable between different opening positions of the plurality of opening positions.

Moving the closure element to a variably adjustable, stable distance from the seat can be achieved, for example, by using the adjustment device to adjust a maximum distance, in particular in the open position of the closure element, between the closure element and the seat of the closure element. It may be advantageous in this case that a travel distance, which in particular the closure element can perform, can be limited between the position of the closure element in the closed position and the position of the closure element in the fully open position.

The adjustment device may additionally or alternatively have a motion thread. This enables a rotary operating movement to be converted into a movement which results in an adjustment of the aforementioned maximum distance.

The adjustment device may further additionally or alternatively have a support spring with which adjustment of the closure element and/or the seat of the closure element can be supported. This makes smooth operation possible.

In practice, it may additionally or alternatively be provided that the at least one variable stop or the at least one counter-stop can be arranged on a movable component of the adjustment device. The movable component may in particular be movable in relation to a housing of the shut-off device and/or to the seat of the closure element. The arrangement of the at least one variable stop with a movable component of the adjustment device allows the at least one variable stop to be arranged in a coordinated manner with the position and/or orientation of the movable component.

In particular, the at least one variable stop or the at least one counter-stop can be detachably connected to the movable component. The detachable connection allows the position and/or orientation of the at least one variable stop to be variably adjusted to the position and/or orientation of the movable component. The detachable connection can be, for example, a form-fitting connection. A form-fitting connection can be detached and reattached particularly easily.

In practice, it may additionally or alternatively be provided that the adjustment device is designed as a mechanism with an actuator, wherein the at least one variable stop can be variably arranged on the actuator.

This mechanism may be a rotary mechanism in particular. A mechanism is particularly easy to manufacture and robust in use. A rotary mechanism can be particularly easy for a user to operate.

In particular, the actuator can be the movable component of the adjustment device described. In addition or alternatively, the actuator can be an actuator that can be rotated by a user, for example. Furthermore, the actuator can be round in a plane of rotation in which the rotatable actuator can be rotated in one direction of rotation, in particular in the direction of rotation described. The actuator can be designed in particular in the form of a sleeve. In addition or alternatively, the actuator can at least partially accommodate the actuating means, which is designed in particular as a manual operating element.

By actuating, in particular rotating, the actuator, the closure element and the seat can be moved relative to each other or away from each other. For this purpose, the adjustment device can, for example, have a motion thread. This makes it possible, in particular, to convert a rotary operating movement into a movement that results in an adjustment of the aforementioned maximum distance. For this purpose, the actuator is preferably mounted so that it can be rotated or pivoted, particularly preferably about an axis aligned centrally with the closure element.

The actuator can be connected to the closure element and/or to the seat of the closure element, in particular by means of a mechanical arrangement.

The at least one variable stop can be detachably arranged on the actuator, in particular by means of a form-fitting connection. The form-fitting connection can act in particular in a direction of rotation and/or a plane of rotation of the rotary mechanism. When the actuator is rotated by a user, the at least one variable stop arranged on the actuator can then be rotated along with it, in particular until the at least one variable stop interacts with the at least one counter-stop, and further in particular until the at least one variable stop contacts the at least one counter-stop.

In particular, if the at least one variable stop can be arranged or is arranged on the actuator as described, the at least one counter-stop can be formed or arranged in a fixed position on the housing of the shut-off device or on a component of the shut-off device that is formed or connected to the housing in a fixed position. This design of the shut-off device is particularly easy to manufacture from a technical point of view and particularly easy for the user to operate.

It is also possible that the at least one variable stop can be arranged on the actuator as described, and the at least one counter-stop can also be variably arranged on the housing of the shut-off device, or variably arranged on the component of the shut-off device that is fixed in position with the housing or connected to it. This allows the at least one variable stop and the at least one counter-stop to be arranged in different positions and/or orientations, in particular independently of each other, so that a particularly high degree of flexibility is possible when presetting the shut-off device.

It is also possible that the at least one counter-stop is arranged or formed in a fixed position on the actuator and the at least one variable stop is arranged variably on the housing of the shut-off device or on a component of the shut-off device that is formed or connected to the housing in a fixed position. This makes it possible to use the available installation space in the shut-off device, on the shut-off device, and/or around the shut-off device in a particularly flexible and effective manner.

Preferably, the actuator and the at least one variable stop connected to it in a form-fitting manner can be designed in such a way that the form-fitting connection acts in the direction of rotation and/or the plane of rotation of the rotary mechanism, and the connection can be released in a direction oriented transversely to the direction of rotation and/or the plane of rotation. In this way, the at least one variable stop can be rotated along with the actuator when it is rotated by a user, and the at least one variable stop can be easily removed from the actuator in a direction oriented transversely to the direction of rotation and/or the plane of rotation.

In practice, it may additionally or alternatively be provided that the adjustment device comprises a combination of a control cam and a plurality of shoulders sliding along the control cam. The combination of a control cam and a plurality of shoulders sliding along the control cam is a particularly simple way of converting a rotary movement into a linear movement.

The control cam can, for example, be designed as a sawtooth profile on, for example, an upper end of an inner side of the actuator, which is designed, for example, as a sleeve. The shoulders can, for example, be designed as pins that can move along the control cam, for example, on an outward-facing outer side of the actuating means, which is accommodated, for example, in the actuator. The control cam can then form a limitation of the movement possibility of the actuating means.

If the shut-off device has an adjustment device of the type described here, the actuating means with the bistable actuating mechanism can be adjusted discretely and, in addition, the adjustment device can be adjusted continuously. In this way, for example, the described adjustment range that the closure element can perform can be limited between the position of the closure element in the closed position and the position of the closure element in the fully open position.

In practice, it may additionally or alternatively be provided that the actuator has a plurality of guide elements extending transversely to a direction of movement, in particular transversely to a direction of rotation or a plane of rotation of the rotary mechanism, for receiving a cover cap, wherein the at least one variable stop can be arranged on one or more of these guide elements.

The guide elements may be, for example, guide tracks, guide grooves, or guide channels. The individual guide elements of the plurality of guide elements may, in particular, be geometrically identical.

The guide elements can advantageously serve to enable a cover cap to be easily placed on the actuator and on the actuating means partially accommodated in the actuator, and to enable the actuator to be rotatably connected to the cover cap, in particular transversely to the guide of the guide elements. The cover cap may have a coupling geometry corresponding to the guide grooves in order to form a connection with the actuator. In addition, the guide elements may advantageously serve at the same time to accommodate the at least one variable stop.

The cover cap may in particular have a movable section, for example a pressure point, so that as a result of pressure being exerted on the movable section, the actuating means can be displaced in particular parallel to the guide elements in the direction of the closure element and/or the seat of the closure element in order to be able to adjust the closure element. This facilitates usability, as a user can easily distinguish between operation by pressing and operation by turning. Operation by pressing can, for example, cause the closure element to be adjusted from the open position to the closed position and vice versa. Operation by turning can, for example, cause the maximum distance described to be adjusted.

The at least one variable stop can, for example, be insertable into one or more of the guide elements described here, in particular in such a way that at least part of the at least one variable stop protrudes from the guide element or guide elements.

If the actuator is rotatable and, in particular, round, the guide elements can be formed on a jacket surface of the round actuator.

In practice, it may additionally or alternatively be provided that the actuating mechanism and/or the adjustment device has/have a push-push locking mechanism.

The push-push locking mechanism can, for example, be a ballpoint pen mechanism or a heart curve mechanism. In particular, the push-push locking mechanism can be a component of the actuating mechanism.

Due to the push-push locking mechanism, the actuating means, which is designed as a manual operating element, can, for example, be adjustable beyond a stop point. An advantage here is that the bistable actuating mechanism can be controlled, wherein a change from one stable position to another stable position can be achieved by adjusting beyond the other stable position and then falling back into the other stable position.

In practice, it may additionally or alternatively be provided that the at least one variable stop is formed on a ring body.

A ring body is particularly advantageous because it is compact and at the same time enables a firm, secure arrangement of the at least one variable stop. The ring body can, for example, be arranged on the actuator and the counter-stop on the housing of the shut-off device, or on a component of the shut-off device that is fixed in position or connected to the housing. The at least one variable stop is then held by the ring body on the actuator. The ring body can in particular be arranged on the guide elements described here.

It is also possible for the ring body to be arranged on the housing of the shut-off device or on the component of the shut-off device that is fixed in position or connected to the housing. In this case, the at least one counter-stop can be provided on the actuator as described.

In practice, it may additionally or alternatively be provided that the ring body has a toothing.

The toothing may consist in particular of a plurality of teeth formed on the ring body. The teeth may be formed in particular in correspondence with the plurality of guide elements formed on the actuator, and further in particular in such a way that the ring body can be arranged in different positions and/or orientations in relation to the actuator and/or the guide elements. The teeth may additionally or alternatively be arranged in a distributed manner on an inner circumference of the ring body and, for example, protrude inward. The teeth may in particular be distributed on the inner circumference of the ring body with the greatest possible spacing between them. Due to the greatest possible spacing between them, forces can be absorbed particularly well, stresses can be distributed particularly well, and/or a torque from the actuator can be introduced particularly well to the at least one variable stop.

In practice, it may additionally or alternatively be provided that the shut-off device has two of the variable stops, in particular the variably arrangeable stops, and two of the counter-stops cooperating therewith. As described, the flow rate adjustable in the open position can be limited to a variable subset by means of the two stops and the two counter-stops. If the two variable stops and the two counter-stops are formed, a force acting when the stops interact with the counter-stops can be distributed across these elements. This may make it possible to absorb a higher force and/or distribute a force better than if only one stop and one counter-stop are formed. In particular, the shut-off device can be designed so that one of the two variable stops interacts with one of the two counter-stops.

In particular, the two variable stops can be arranged opposite each other. This allows the force acting on them to be distributed particularly evenly when interacting with the counter-stops. The counter-stops can also be arranged opposite each other.

In alternative designs, more than two variable stops, for example three or four variable stops, and/or more than three counter-stops, for example three or four counter-stops, may also be provided.

In practice, it may additionally or alternatively be provided that the shut-off device has an invariable stop and a counter-stop of second type cooperating therewith, wherein the interaction of the invariable stop and the counter-stop of second type limits the flow rate adjustable in the open position.

The invariable stop can, for example, be formed or arranged in a fixed position on the actuator or on a component of the shut-off device connected to the actuator in a rotationally fixed manner. The counter-stop of second type can, in particular, be formed or arranged in a fixed position on the housing of the shut-off device or on the component of the shut-off device formed or connected to the housing in a fixed position.

The invariable stop and the counter-stop of second type can in particular be designed in such a way that they interact with each other in a direction oriented transversely and preferably orthogonally to a direction of movement of the closure element. In addition or alternatively, the invariable stop and the counter-stop of second type can interact with each other in a direction of rotation oriented around the direction of movement of the closure element and in particular around the direction of rotation described here.

Contact between the invariable stop and the counter-stop of second type can, for example, define a maximum opening position of the shut-off device in the open position. In addition or alternatively, contact between the invariable stop and the counter-stop of second type can define a closed position of the shut-off device in the open position, in which no flow through the shut-off device is possible, even though the closure element is arranged in the open position described here and not in the closed position described here. This allows, for example, mechanical stress on the closure element and the seat of the closure element to be reduced and transferred to the invariable stop and the counter-stop of second type.

Due to the invariable stop and the counter-stop of second type, a specific, desired arrangement of the at least one variable stop can be achieved particularly easily. For example, when the closure element is in the open position, the shut-off device can be moved to the fully open position or to the closed position, in which no flow through the shut-off device is possible. With regard to this setting, the at least one variable stop can be arranged, in particular, so that it is visible to a user.

In particular, the at least one variable stop can be arranged with a predetermined offset to the invariable stop, wherein the predetermined offset is associated, for example, with a known change in the possible flow rate through the shut-off device.

In practice, it may additionally or alternatively be provided that the shut-off device is a diaphragm valve with flow adjustment. A diaphragm valve with flow adjustment is particularly easy to operate and compact. In particular, a diaphragm valve with flow adjustment makes it particularly easy to adjust the flow rate of a flowable medium flowing through the diaphragm valve in the open position of the shut-off element by means of at least one variable stop.

In the diaphragm valve with flow adjustment, it may be provided in particular that the closure element and/or the seat can be actuated and, in particular, adjusted by means of the adjustment device and/or the actuating mechanism. Furthermore, the closure element can be actuated by the actuating means, which is preferably designed as a manual operating element. A control element can be operatively connected to the actuating means, which is designed in particular as a manual operating element, wherein the closure element can be actuated by a distal end of the control element relative to the position of the actuating means. The control element may in particular be a component of the aforementioned mechanical arrangement by means of which the actuator and/or the actuating means may be connected to the closure element and/or to the seat of the closure element.

In addition or alternatively, a compensating device may be formed or arranged in the operative connection between the control element and the actuating means. The compensating device may have a plunger guided movably in a receptacle and allow relative movement of the actuating means against the control element.

If the shut-off device has the adjustment device and the control element, the maximum distance between the seat and the closure element, which can be adjusted with the described adjustment device, can be adjusted, for example, in such a way that the adjustment device is able to adjust or can adjust a maximum distance between the actuating means and the distal end of the control element, relative to the position of the actuating means. For example, the control element can be adjustable in its position independently of the actuating means, or the actuating means can be adjustable in its position independently of the control element. Alternatively or additionally, the maximum distance between the seat and the distal end of the control element can be adjustable by making the actuating means adjustable in position together with the control element. The compensating device can also be used to achieve the adjustability of the actuating means beyond the stop point described in connection with the push-push locking mechanism.

Alternatively or additionally, a return element may be provided which opposes the relative movement described here with a return force. In connection with the push-push locking mechanism, the return element can allow the necessary freedom of movement between the receptacle and the plunger, since the control element cannot be moved beyond the further stable position described in connection with the push-push locking mechanism, in which the closure element is arranged, for example, in the closed position. The return element can thus simultaneously transmit an actuating force for adjusting the closure element. The return element can, for example, be arranged outside the compensating device. This prevents the return element in the receptacle from impeding the mobility of the plunger.

The receptacle can form a boundary against which the return element presses the plunger in a rest position. This allows a defined rest position to be formed.

The plunger can be formed in particular at a proximal end of the control element relative to the position of the actuating means. This makes it easy to ensure that the plunger and the control element are made of the same material. It is also possible for the receptacle and the control element to be made of different materials. This is advantageous because the receptacle can be easily manufactured in plastic as a complex shape, while a metallic material may be more suitable for the control element in order to achieve greater load-bearing capacity and buckling resistance.

The adjustment device can be arranged in particular between the compensating device and the actuating means, which is designed in particular as a manual operating element. This allows a compact actuating device to be formed. The adjustment device can thus be easily arranged outside a sealed area of the shut-off device. In this case, it is advantageous if the adjustment device is designed to adjust a distance between the compensating device and the actuating means. This makes it easy to limit the adjustment travel of the closure element by shifting the rest position of the plunger in the receptacle.

It may also be provided, additionally or alternatively, that the receptacle of the compensating device is fixedly designed or arranged on the actuating means, which is designed in particular as a manual operating element. This means that the receptacle can be easily and safely operated and adjusted manually from the outside.

Furthermore, additionally or alternatively, it may be provided that the shut-off device, which is designed in particular as a valve, has a pressure chamber which is connected fluidically to the inlet of the shut-off device via a filling opening and to the outlet of the shut-off device via an outlet opening, wherein the closure element can be acted upon by means of a pressure generated in the pressure chamber. The closure element described may then be a first closure element, which may also be referred to as the main closure element, and the seat described above may be a main seat. The outlet opening can be opened and closed by means of a second closure element, which can, for example, be part of a pilot valve. This allows a servo actuator to be formed, which uses fluid pressure applied to the inlet to amplify a control force applied via the actuating means. The described compensating device enables the main closure element, in particular together with the second closure element, to be tracked or trackable when the pressure in the pressure chamber builds up and the main closure element can be pressed against its seat. Thus, the outlet opening can be kept closed by the second closure element being movable. This means that actuation can be performed with comparatively little effort. The amplification can be achieved by pressure in the pressure chamber, which can be switched via the actuator between a filled, pressurized and thus closing state and a depressurized, releasing state.

Preferably, the second closure element can be arranged or formed at the distal end of the control element. This eliminates the need for additional transmission elements between the control element and the second closure element. This simplifies the design.

The pressure chamber can be sealed, in particular, by a seal relative to the actuating means. This makes it easy to seal the pressure chamber to the outside. In particular, it can be provided that the seal rests against the control element. This allows the control element to enter the pressure chamber. Alternatively or additionally, it may be provided that the seal rests against the compensating device. This allows an alternative introduction of an actuating movement into the pressure chamber, in particular for adjusting the second closure element in particular.

In addition or alternatively, it may be provided that the main closure element has a fixed main body and an elastic diaphragm supporting the main body, with which the main body is suspended on the housing of the shut-off device. Thus, the main closure element, in particular the fixed main body, can be easily moved and is simultaneously securely fastened. The main body can be placed on the main seat and have the filling opening. In this context, a cleaning pin protruding into the filling opening can also be provided. When the main body moves with the filling opening in relation to the cleaning pin, self-cleaning during operation can be enabled.

The pressure chamber can be bounded in particular by the diaphragm fixed in particular to the housing. This allows a substantially double-shell pressure chamber to be formed, which is easy to manufacture. Particularly advantageous here is a combination with the aforementioned seal against the actuating means. In particular, it may be provided that the diaphragm is clamped between two housing parts of the housing of the shut-off device. This allows the diaphragm to be held simply and tightly to the housing.

The aforementioned outlet opening of the pressure chamber can be arranged in an extension of the control element. This allows the second closure element for opening and closing the outlet opening to be easily and directly controlled by the control element, especially if it is rod-shaped.

The seat, in particular the main seat, can be designed to be ring-shaped, for example. In particular, the first and/or second closure element(s) can be movable orthogonally to a surface defined by the associated seat. The seat can then serve as a secure support for the respective closure element.

The outlet can, for example, be arranged in an extension of the outlet opening. This allows for a space-saving design in which, for example, the control element, the second closure element, and the main closure element are arranged one behind the other on an imaginary line.

In addition or alternatively, the shut-off device can be designed so that the return element acts on the control element. This allows the return force to be applied directly to the control element. A space-saving design is also possible. The return element can, for example, act on tension or pressure. It is preferable for the control element to be acted upon by pressure from the return element. This enables a small construction dimension along the control element, with which support of the return force can be easily achieved.

The return element can be a coil spring, for example. This means that a return force can be developed with a structurally simple component. A return force along the control element is easy to develop.

The actuating means may be acted upon by an actuating means return spring. If the actuating means is designed as a manual operating element, the actuating means return spring may also be referred to as a manual operating element return spring. An advantage of the design of the actuating means return spring is that the actuating means can be returned independently of the compensating device. In particular, if the return element is provided, it may be provided that the actuating means return spring develops a greater force than the return element. This means that a force that can be generated with the return element can be easily overcome by a force that can be generated with the actuator return spring. Preferably, the return forces of the return element on the one hand and the actuator return spring on the other hand are aligned parallel and/or in opposite directions to each other.

In particular, it may be provided that the actuating means return spring is designed as a coil spring, in particular wherein the actuating means return spring surrounds the control element and/or the compensating device. This allows for a space-saving arrangement.

The actuating means may in particular be designed such that it at least partially accommodates or overlaps the compensating device and/or the control element in a hood-like manner. This allows a small longitudinal dimension of the actuating device to be achieved.

The control element can, for example, be designed in the form of a rod and/or have a thickened cross-section at an end facing away from the closure element. This allows a contact surface to be formed with which the control element can be held in a rest position in the receptacle of the compensating device. The control element, which is in particular rod-shaped, can, for example, be arranged so that it can be displaced in the longitudinal direction. This allows the control element to be guided in a simple linear manner.

In addition or alternatively, it may be provided that a cross-sectional area at the outlet opening that can be covered by the second closure element is larger than a cross-sectional area of the control element at its exit from the pressure chamber. This prevents the closure element from automatically moving away from the outlet opening and releasing it in an uncontrolled manner, for example in the event of a pressure surge transmitted to the pressure chamber. A further advantage is that the return element, with which the closure element can be moved into its closed position, can be equipped with a low spring force. This has the further advantage that the actuating means return spring, which can cause a return movement of the actuating means, also does not need to be dimensioned with a large spring force. In this way, smooth switching behavior can be achieved.

It is preferably provided that the second closure element is arranged at the distal end of the control element. This makes it easy to control the second closure element, for example via the actuating means described. The coverable cross-sectional area can, for example, be at least twice as large as the cross-sectional area of the control element. For example, the coverable cross-sectional area can be defined by a pilot valve seat that interacts with the second closure element.

It may again additionally or alternatively be provided that a pilot valve seat which can be closed and released with the second closure element can be provided on the main body, and the outlet opening can form a preferably funnel-shaped constriction behind the pilot valve seat in the direction of flow. It is advantageous that the outlet opening can be designed to be as small as possible, for example, with a diameter that is at most half or even at most a quarter of the size of the pilot valve seat.

### BRIEF DESCRIPTION OF THE DRAWINGS

The invention will now be explained in more detail using an exemplary embodiment, but is not limited to this exemplary embodiment. Further exemplary embodiments result from combining the features of individual or several claims with each other and/or with individual or several features of the exemplary embodiment, wherein:

FIG. 1 shows a three-dimensional external view of a shut-off device described herein,

FIG. 2 shows a longitudinal section of the shut-off device from FIG. 1,

FIG. 3 shows an actuating means and actuator of the shut-off device shown in FIG. 1, each in an isolated three-dimensional representation,

FIGS. 4A, 4B show a comparison of the shut-off device from FIG. 1 with and without the housing partially removed, to illustrate the at least one variable stop and the invariable stop, in a first opening position,

FIGS. 5A, 5B show a comparison of the shut-off device from FIG. 1 in a representation analogous to FIGS. 4A, 4B, with a variable stop arranged offset from that in FIGS. 4A, 4B,

FIG. 6 shows an alternative variant of the shut-off device described here with two variable stops and two counter-stops, in a three-dimensional external view from above.

### DETAILED DESCRIPTION

In the following description of various figures, elements that have the same function are given the same reference signs, even if their design or shape differs. For the sake of clarity, not all reference signs are shown in the figures, even though the elements may well be present in the figures.

First, the general structure and mode of operation of an exemplary embodiment of a shut-off device according to the invention are described below. Details of the at least one variable stop of the shut-off device are then described.

The figures show the same exemplary embodiment of the shut-off device for a flowable medium described here. In the exemplary embodiment shown in the figures and described here, the shut-off device 1 is designed as a valve 1.

The valve 1 can be switched discretely between a closed state and an open state. In the closed state, the valve 1 can prevent the flow of a flowable medium. In the open state, the valve 1 can allow the flow of a flowable medium. In the open state, a flow rate of a flowable medium, which can lie between a maximum possible flow rate in the open state and the flow prevented by the shut-off device 1, can be continuously adjusted. This state, in which the flow rate of the flowable medium lies between the maximum possible flow rate in the open state and the prevented flow, can also be referred to as an intermediate state.

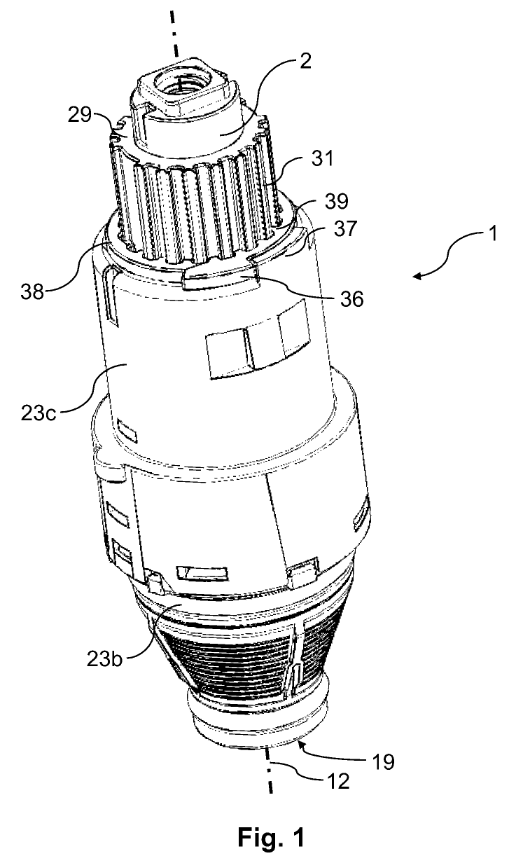

FIGS. 1, 2, 4A, 4B, 5A and 5B show valve 1 in the open state. In particular, valve 1 is in an intermediate state in which flow through valve 1 is completely prevented. The flow is therefore identical to the flow in the closed state of valve 1.

Switching between the open state and the closed state is effected by means of an actuating means 2 of valve 1, wherein the actuating means 2 is designed as a manual operating element 2 in the exemplary embodiment described here and serves to displace a first closure element 3 designed as a main closure element 3.

The main closure element 3 of valve 1 rests in a sealing manner against a first seat 4 of valve 1, which is designed as a main valve seat 4. The main closure element 3 and the main valve seat 4 thus together form a main shut-off device designed as a main valve.

By switching valve 1 from the closed state to the open state, the main closure element 3 can be moved so that it is at a predefined distance from the main valve seat 4. Depending on the predefined distance between the main closure element 3 and the main seat 4 in the open state, the flow of a flowable medium can be throttled more weakly or more strongly (weaker throttling if the distance is large and stronger throttling if the distance is small).

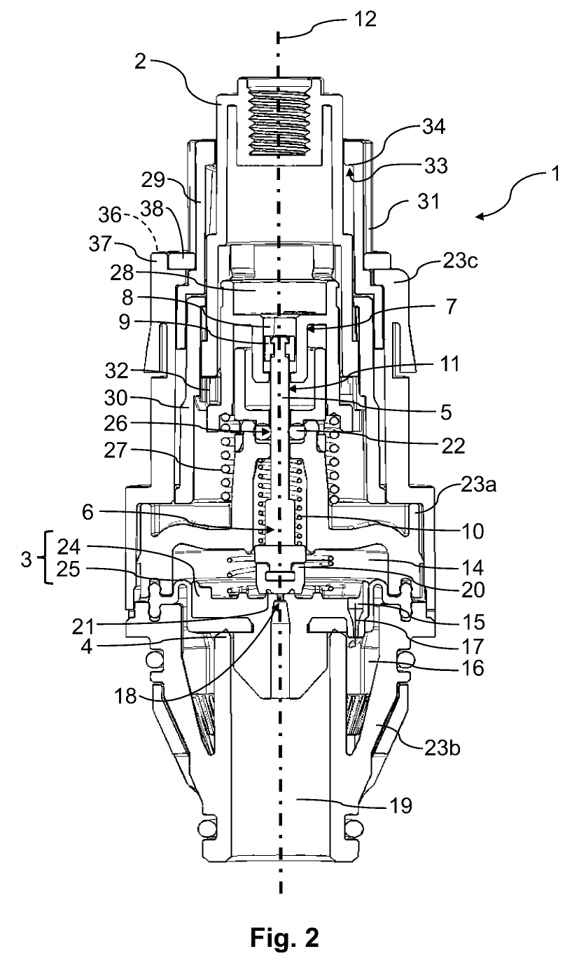

A control element 5, which can be seen in particular in FIG. 2, is arranged between the manual operating element 2 and the main closure element 3, which transmits an operating movement exerted by a user on the manual operating element 2 to the main closure element 3.

At a distal end 6 of the control element 5, relative to its position in relation to the manual operating element 2, the control element 5 is coupled to the main closure element 3 in such a way that the main closure element 3 can be moved between the open position and the closed position with the control element 5. In particular, the distal end 6 of the control element 5 is movably engaged with the main closure element 3.

The coupling is, for example, detachable and, in particular, loose, so that in the movable arrangement, a movement of the control element 5 in the direction of the main closure element 3 causes a displacement of the main closure element 3, and a movement of the main closure element 3 in the direction of the control element 5 causes a displacement of the control element 5. If the control element 5 moves in the opposite direction to the main closure element 3 and/or if the main closure element 3 moves in the opposite direction to the control element 5, the main closure element 3 and the control element 5 can be separated from each other.

This coupling can be advantageous for the functionality of the valve 1. This is because, due to this coupling, the main closure element 3 and the control element 5 can be moved together or separately in different situations.

A compensating device 7, which can be seen in FIG. 2, is formed between the manual operating element 2 and the control element 5, which transmits the actuation of the manual operating element 2 to the control element 5.

For this purpose, the compensating device 7 has a receptacle 8 in which a plunger 9 is guided linearly in a sliding manner. This freedom of movement of the plunger 9 means that the control element 5 is movable relative to the manual operating element 2.

In order to hold the control element 5 in a preferred rest position relative to the manual operating element 2, a return element 10 is formed in the valve 1. This return element 10 develops a return force to hold the control element 5 in the rest position in the receptacle 8, provided that the position of this control element 5 allows this.

The return element 10 is arranged outside the compensating device 7 and, in particular, outside the receptacle 8. This prevents any obstruction of the sliding movement of the plunger 9 in the receptacle 8. The plunger 9, which is guided in the receptacle 8, is directly mechanically connected to the proximal end 11 of the control element 5 relative to the position of the manual operating element 2.

The receptacle 8 of the compensating device 7, on the other hand, is connected to the manual operating element 2.

The longitudinal axis 12 of the valve 1 defines a plunger guide direction along which the plunger 9 is guided in a displaceable manner in the receptacle 8.

As can be seen in particular in FIG. 2, the valve 1 has a pressure chamber 14 which is connected fluidically to an inlet 16 of the valve 1 via a filling opening 15. A cleaning pin 17 is arranged in the filling opening 15 to prevent the filling opening 15 from becoming clogged. The pressure chamber 14 is fluidically connected to an outlet 19 of the valve via an outlet opening 18.

The pressure chamber 14 is designed such that the control element 5 is arranged in the pressure chamber 14 with at least one section containing the distal end 6. The pressure chamber 14 is sealed against the manual operating element 2 and against a section of the control element 5 containing the proximal end 11 by a seal 22. The seal 22 rests against a component 23a of the valve 1, which is a housing part 23a of a housing of the valve 1.

The compensating device 7 is located in FIG. 2 above the seal 22 and consequently outside the pressure chamber 14. The control element 5 is arranged so that it can be displaced in the housing part 23a. When the valve 1 is switched, the seal 22 is moved along with the compensating device 7. The seal 22 is a sealing ring surrounding a passage opening 26 through which the control element 5 is guided in a sealing manner from the pressure chamber 14 to the outside, so that the pressure chamber 14 is closed at the top in the representation shown in FIG. 2.

On the side opposite the passage opening 26, the pressure chamber 14 is closed off by the main closure element 3.

The main closure element 3 has a main body 24 and a diaphragm 25. The diaphragm 25 is designed to be essentially ring-shaped and is arranged with an inner edge sealingly on a circumference of the main body 24. With an outer edge, the diaphragm 25 is clamped sealingly between the components 23a and 23b designed as housing parts. The diaphragm 25 supports the main body 24 with the filling opening 15. Due to the vibratory diaphragm 25, the main closure element 3 and, in particular, the main body 24 are capable of vibrating along the longitudinal axis 12, i.e., they are connected to the housing parts 23a, 23b in a movable manner.

The pressure chamber can therefore be closed, with the exception of the filling opening.

When a pressure of a flowable medium is applied in the inlet 16, the pressure chamber 14 is filled with the flowable medium through the filling opening 15.

With the aid of the flowable medium and a pressure generated thereby in the pressure chamber 14, the main closure element 3 can be easily adjusted and thus the outlet 19 can be fluidically separated from the inlet 16 or fluidically connected thereto. This creates a servo actuator which, by means of the fluid pressure applied to the inlet 16, amplifies a control force applied via the manual operating element 3.

To ensure that the servo actuator functions particularly easily, the control element 5 is connected at its distal end 6, relative to the position of the manual operating element 2, to a second closure element 20. The second closure element 20 is designed as a pilot closure element.

Corresponding to the pilot closure element 20, the outlet opening 18 is formed in the main closure element 3. The outlet opening 18 is surrounded by a second seat 21 of the valve 1, which is designed as a pilot valve seat. In the region of the pilot valve seat 21, the outlet opening 18 has a cross-section that is larger than the cross-section of the filling opening 15. The pilot closure element 20 and the pilot valve seat 21 together form a pilot shut-off device designed as a pilot valve. The outlet opening 18 can thus be closed with the pilot closure element 20 when the pilot closure element 20 rests against the pilot valve seat 21, or opened, i.e. released, when the pilot valve 20 does not rest against the pilot valve seat 21.

The pilot closure element 20 can thus be used to control whether pressure builds up in the pressure chamber 14 through the filling opening 15, which is the case when the outlet opening 18 is closed, or whether this built-up pressure is released again by the pilot closure element 20 opening the outlet opening 18.

FIG. 2 shows that the outlet opening 18 and the outlet 19 are arranged one behind the other in an extension of the control element 5 along the longitudinal axis 12, i.e., along the direction of adjustment of the control element 5.

For particularly easy switching of the valve 1, the cross-section of the outlet opening 18 that can be covered by the pilot closure element 20 is large enough that the pilot closure element 20 with the control element 5 is driven by internal pressure in the pressure chamber 14 in the direction of a closed position in which the outlet opening 18 is closed.

This is achieved in particular by the fact that the cross-sectional area at the outlet opening 18 that can be covered by the pilot closure element 20 is larger than a cross-sectional area of the control element 5 at its exit from the pressure chamber 14, i.e., in the region of the passage opening 26. Due to the larger cross-sectional area at the outlet opening 18, a flowable medium in the pressure chamber 14 ultimately pushes the control element 5 with greater force in the direction of the outlet opening 18.

This means that the return element 10, which also drives the control element 5 in the direction of the outlet opening 18, can be dimensioned with a comparatively low spring force. This allows the manual operating element return spring 27, which drives the control element 5 via the manual operating element 2 and the plunger 9 in the opposite direction to the outlet opening 18, to also be dimensioned with a comparatively low spring force. In this way, smooth switching behavior can be achieved.

The return element 10 is designed as a coil spring and applies pressure to the control element 5. The return element 10 is supported by the housing part 23a.

The manual operating element 2 is acted upon by the manual operating element return spring 27, which is also supported on the housing part 23a. In order for the manual operating element 2 to move the control element 5 into the open position, which opens the outlet opening 18, the manual operating element return spring 27 is designed to develop a greater force than the return element 10.

Both the return element 10 and the manual operating element return spring 27 are designed as coil springs that surround and accommodate the control element 5.

The compensating device 7 is arranged along the longitudinal axis 12 above the manual operating element return spring 27.

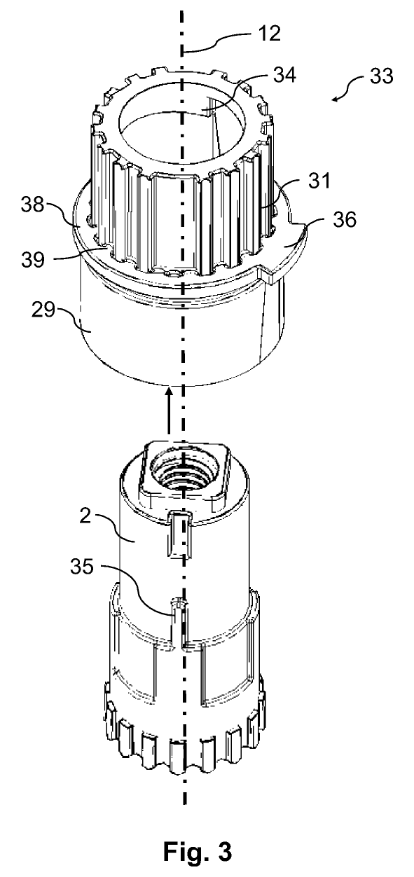

As shown in FIG. 2 and FIG. 3, the manual operating element 2 is hood-shaped and accommodates the compensating device 7 in its interior 28. At the same time, the manual operating element 2 is held at least partially in a first sleeve 29 and in a second sleeve 30. The first sleeve 29 forms an actuator 29.

The actuator 29 has a round basic shape and has a plurality of guide elements 31 in an upper area radially on the outside, on which a cover cap with a corresponding coupling geometry, not shown in the figures, can be arranged from above on the manual operating element 2. The cover cap arranged on the guide elements 31 can be rotated or pivoted together with the manual operating element 2 in the housing part 23c or on the housing part 23c.

The second sleeve 30 is partially inserted into the actuator 29 and is rotationally fixed with respect to the valve housing. The actuator 29 and the second sleeve 30 are each fixed in the longitudinal axis 12 and each form a limit for movement of the manual operating element 2 along the longitudinal axis 12.

The valve 1 has a bistable actuating mechanism 32 which forms a push-push locking mechanism, for example a ballpoint pen mechanism or a heart curve mechanism. With the actuating mechanism 32, the manual operating element 2 is fixed to the second sleeve 30 between an upper position, in which the main closure element 3 can assume the open position, and a lower position in which the main closure element 3 can assume the closed position, by pressing along the longitudinal axis 12 discretely, i.e. without assuming a stable intermediate position.

Valve 1 also has an adjustment device 33 designed as a rotary mechanism, which is shown in particular in FIG. 3. The adjustment device 33 can be used to adjust the maximum distance between the pilot closure element 20 and the aforementioned limit in the actuator 29 for the movement of the manual operating element 2 along the longitudinal axis 12. Since the main closure element 3 regularly rests against the pilot closure element 20, which can be adjusted by means of the adjustment device 33, in the open position, the main closure element 3 can be arranged in the open position in a plurality of opening positions by means of the adjustment device 33. Each opening position defines a predetermined flow rate of the flowable medium through the valve 1.

As can be seen from FIG. 3, the adjustment device 33 comprises the actuator 29 and a combination of a control cam 34 and a plurality of shoulders 35 sliding along the control cam 34. The control cam 34 forms the aforementioned limitation in the actuator 29 for the manual operating element 2. In the embodiment described here, the control cam 34 is designed as a sawtooth profile at the upper end of the radially inward-facing inner side of the actuator 29. The shoulders 35 are designed as pins that can move along the control cam 34 on the radially outward-facing outer side of the manual operating element 2. When the actuator 29 is rotated or pivoted about the longitudinal axis 12, the manual operating element 2 can be moved with the shoulders 35 along the control cam 34 and thus along the longitudinal axis 12.

The manual operating element 2 can thus be adjusted discretely along the longitudinal axis 12 with the actuating mechanism 32 and can also be adjusted continuously along the longitudinal axis 12 with the adjustment device 33.

The states of the valve and the switching of the valve between the states are summarized again below.

In FIG. 2, the main closure element 3 is in the open position, but the main closure element 3 has been brought into direct contact with the main valve seat 4 by stepless adjustment.

To switch from the open state of the valve 1 to the closed state of the valve 1, the manual operating element 2 can be pressed along the longitudinal axis 12 due to the actuating mechanism 32, and the main closure element 3 can be adjusted discretely between the open position and the closed position.

By pressing the manual operating element 2 when valve 1 is in the open position, the pilot closure element 20 is pressed against the pilot valve seat 21 by means of the manual operating element 2 and the main closure element 3 is pressed against the main valve seat 4. This builds up pressure in the pressure chamber 14, which presses the pilot closure element 20 against the pilot valve seat 21 and the main closure element 3 against the main valve seat 4 even when the manual operating element 2 is released, thus keeping the valve 1 in the closed state.

To return the valve 1 from the closed state to the open state, the manual operating element 2 can be pressed again along the longitudinal axis 12.

Pressing the manual operating element 2 along the longitudinal axis 12 causes the receptacle 8 to initially move downwards relative to the plunger 9.

The mobility of the plunger 9 in the receptacle 8 allows the manual operating element 2 to be moved beyond an end of the adjustment path for the control element 5 specified by the pilot closure element 20. This is advantageous in a push-push locking mechanism, as it allows the lower dead center (in relation to the push movement) or stable point to be exceeded in order to return the manual operating element 2 from a lower position to an upper position.

When the manual operating element 2 is moved to the upper position, it takes the plunger 9 and the control element 5 with it. This is because the plunger 9 connected to the control element 5 has a larger cross-section than a passage opening for the control element 5 in a lower contact surface of the receptacle 8 through which the control element 5 is guided into the receptacle 8. The plunger 9 can thus rest against the lower contact surface of the receptacle 8 and be moved upward when the manual operating element 2 is moved to the upper position.

In this situation, the pilot closure element 20 releases the outlet opening 18. However, since pressure is still built up in the pressure chamber 14, the main closure element 3 initially remains in its closed position.

However, as already mentioned, the outlet opening 18 is larger than the filling opening 15, so that the pressure in the pressure chamber 14 is reduced via the outlet opening 18 and the outlet 19.

This causes the pressure in the inlet 16 to lift the main closure element 3 with the diaphragm 25, so that the inlet 16 and the outlet 19 can be fluidically connected.

When the main closure element 3 is in the open position, the flow of a flowable medium from the inlet 16 to the outlet 19 is influenced by the distance between the main closure element 3 and the main valve seat 4.

In order to adjust the valve 1 in the open state to one of the possible intermediate states, the adjustment device can be used to continuously change the position of the manual operating element 2 and thus the opening position of the main shut-off element 3. When the manual operating element 2 with the shoulders 35 formed thereon is rotated about the longitudinal axis 12, the shoulders 35 move downwards or upwards on the control cam 34 in the actuator 29, taking the manual operating element 2 with them. This means that a maximum distance between the main valve seat 4 and the distal end 6 of the control element 5, i.e., a distance between the main valve seat 4 on the one hand and the distal end 6 or the pilot closure element 20 attached to it on the other hand, can be adjusted when the valve 1 is not in the closed state.

An opening cross-section at the main valve seat 4, through which a flowable medium can flow from the inlet 16 into the outlet 19, can thus be changed in the open position of the main closure element 3.

If the pilot closure element 20 is brought close to the outlet opening 18 when the valve 1 is in the open state, this can lead to a brief closure of the outlet opening 18 and thus to a renewed build-up of pressure in the pressure chamber 14. Since the manual operating element 2 is still in its upper position, the main closure element 3 is not pressed down to the main valve seat 4 by the pressure build-up, but is only pressed down until the outlet opening 18 is open again. This is because the pilot closure element 20 cannot follow the main closure element 3 any further due to the position of the manual operating element 2 until the latter reaches the main valve seat 4.

In this open state of the pilot valve, the pressure chamber 14 is relieved again, so that the main closure element 3 again tends to move upwards. This results in a floating equilibrium state in which the main closure element 3 is positioned in an intermediate position and in which the inlet 16 is partially open, so that a reduced flow between the inlet 16 and the outlet 19 is established compared to the fully open position of the main closure element 3. This achieves a reduced maximum distance between the main valve seat 4 and the distal end 6 of the control element 5 compared to the fully open state of the valve 1.

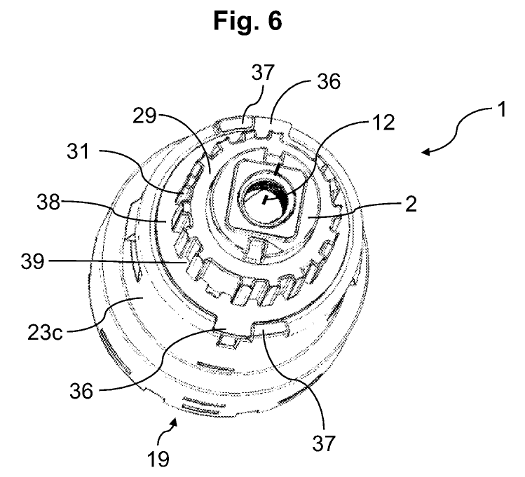

In order to allow, for example, a low flow rate to be easily and precisely adjusted with the valve 1 described here, the valve 1 has at least one variable stop 36, shown in particular in FIGS. 1, 4A, 4B, 5A, and 5B, and at least one counter-stop 37 that interacts with it. In the variant shown in FIGS. 1 to 5B, the valve has exactly one variable stop 36 and exactly one counter-stop 37 that interacts with it. However, several variable stops 36 and several counter-stops 37 that interact with them can also be formed, as described in connection with FIG. 6.

By means of the variable stop 36 and the counter-stop 37, the flow rate adjustable in the open position of the main shut-off element 3 can be limited to a variable subset.

For this purpose, the variable stop 36 is formed on a ring body 38 connected detachably to the actuator 29, and the counter-stop 37 is formed rigidly on the housing part 23c of the housing of the valve 1. As described, the actuator 29 is a movable component of the adjustment device 33.

When the actuator 29 is rotated or pivoted about the longitudinal axis 12 in the open state of the valve 1, the ring body 38 and the variable stop 36 are rotated or pivoted together with the actuator 29. The variable stop 36 can thus be moved toward the counter-stop 37 formed rigidly on the housing of the valve 1 or away from the counter-stop 37, for example until the variable stop 36 contacts the counter-stop 37 or until the aforementioned shoulders 35 reach a limit in the control cam 34. When the variable stop 36 contacts the counter-stop 37, they interact with each other in a direction of rotation oriented orthogonally to the direction of movement of the closure element 3.

The variable stop 36 is variably arranged or can be arranged on the plurality of guide elements 31 on the actuator 29 by means of the ring body 38. For this purpose, the ring body 38 has a toothing 39 corresponding to the guide elements 31.

Since the guide elements 31 are designed transversely to the direction of rotation of the actuator 29 and, in particular, parallel to the longitudinal axis 12, the ring body 38 can be removed from the actuator 29 along the guide elements 31 and rotated transversely to the guide elements 31 with the actuator 29. As described, the main closure element 3 can assume any opening position of a plurality of opening positions defined by the rotation in the open position, which defines a predetermined flow rate of the flowable medium through the valve 1.

In the opening position occupied by the main closure element 3, the ring body 38 with the variable stop 36 formed thereon can be arranged on the actuator 29 in such a way that the variable stop 36 contacts the counter-stop 37, as shown in FIGS. 1, 4A, 4B, 5A, and 5B. The opening position set in this way can also be referred to as the stop position of the main closure element 3, since it is coupled to an arrangement of the variable stop 36, in particular to a positioning and/or orientation of the variable stop 36 on the actuator 29.

If the actuator 29 is rotated from the stop position so that the variable stop 36 moves away from the counter-stop 37 and is later rotated again so that the variable stop 36 approaches the counter-stop 37, it is not possible to rotate the actuator 29 beyond the contact of the variable stop 36 with the counter-stop 37. Thus, the plurality of opening positions originally occupiable by the main closure element 3 is limited or limitable to a subset of this plurality by the variable stop 36 and the counter-stop 37.

Since the variable stop 36 can be variably arranged on the actuator 29, the subset to which the set of opening positions can be limited is variable. In other words, it is possible to exclude different opening positions.

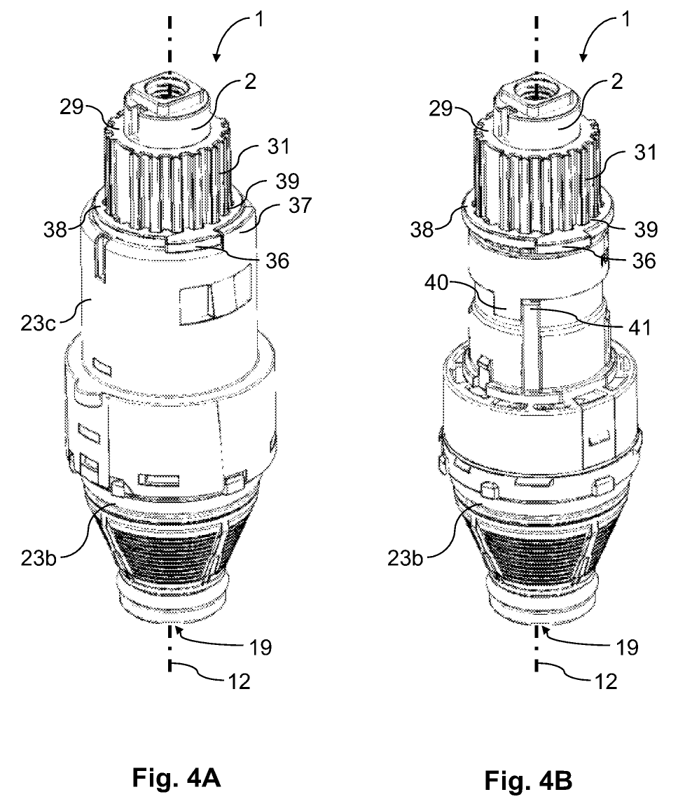

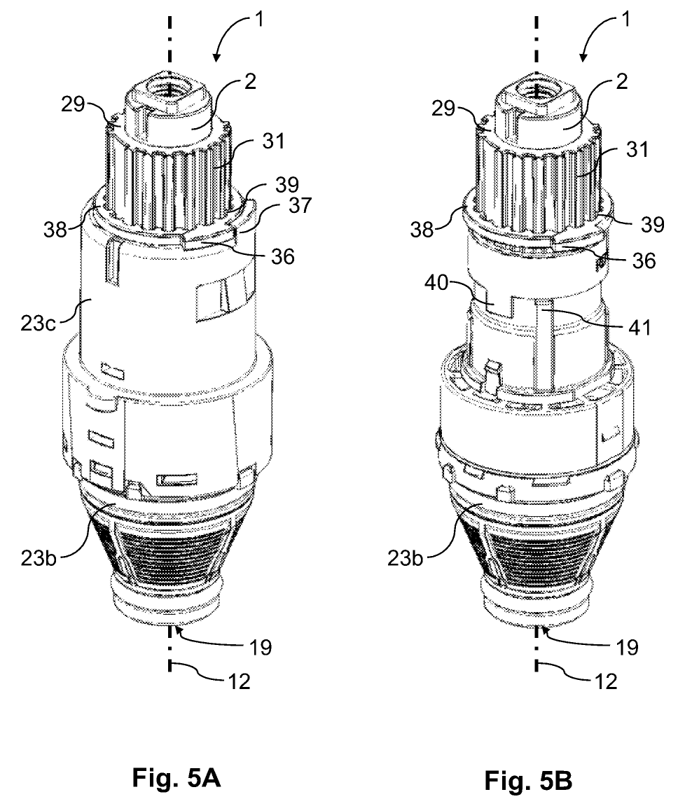

As can be seen in particular from a comparison of FIGS. 4A, 4B and FIGS. 5A, 5B, it is possible to remove the ring body 38 and the variable stop 36 from the actuator 29 and, with the valve 1 in the open state, to move the main closure element 3 completely to the main valve seat 4 using the adjustment device 33, so that flow is prevented. This position is shown in FIGS. 4A and 4B and represents a minimum opening position that defines a minimum flow rate of the flowable medium through the valve 1. In the present exemplary embodiment, the minimum flow rate is identical to the flow rate when the valve 1 is closed.

As shown in FIG. 4B, in the exemplary embodiment described here, when the main closure element 3 is in the minimum opening position, an invariable stop 40 formed in a fixed position on the actuator 29 rests against a counter-stop of second type 41 formed in a fixed position on the second sleeve 30. The invariable stop 40 and the counter-stop of second type 41 interact in a direction of rotation oriented orthogonally about the direction of movement of the closure element 3. Since the second sleeve 30 is arranged so as to be rotationally fixed relative to the housing of the valve 1, the counter-stop of second type 41 is also arranged so as to be rotationally fixed to the housing and can thus limit the rotation of the actuator 29 even when the variable stop 36 is not arranged.

Starting from the minimum opening position shown in FIGS. 4A and 4B, the actuator 29 can be rotated so that the main closure element 3 is moved out of the minimum opening position. In the opening position thus set, which the valve 1 shown in FIGS. 5A and 5B has assumed, a slightly larger flow rate of the flowable medium can flow through the valve 1 than in the minimum opening position. In this opening position, the invariable stop 40 is spaced apart from the counter-stop of second type 41. The variable stop 36 can also be applied to the actuator 29 in such a way that the variable stop 36 contacts its counter-stop 37. Thus, the variable stop 36 can be variably arranged in relation to the minimum opening position. It is then no longer possible to move the main closure element 3 into the minimum opening position, in which flow is prevented.

Alternatively, it is also possible to set the maximum distance described between the main closure element 3 and the main valve seat 4 in the open state of the valve 1 to the maximum possible using the adjustment device 33, so that a maximum flow rate can be achieved (not shown in the figures). This position represents a maximum opening position that defines a maximum flow rate of the flowable medium through the valve 1. When the main closure element 3 is in the maximum opening position, the invariable stop 40, which is fixed in position on the actuator 29, can rest against a further or alternative counter-stop of second type fixed in position on the second sleeve 30 (not shown).

Starting from the maximum opening position, the actuator 29 can be rotated so that the main closure element 3 is moved out of the maximum opening position. In the opening position set in this way, a slightly smaller flow rate of the flowable medium can flow through the valve 1 than in the maximum opening position. In this opening position, the invariable stop 40 can be spaced apart from the further counter-stop of second type 41. The variable stop 36 can also be attached to the actuator 29 in such a way that the variable stop 36 contacts its counter-stop 37. This means that the variable stop 36 can be positioned variably in relation to the maximum opening position. It is then no longer possible to move the main closure element 3 to the maximum opening position.

FIG. 6 shows an alternative variant of the shut-off device. This variant differs from the shut-off device described in connection with FIGS. 1 to 5B solely in the number of stops 36 and the number of counter-stops 37. In the valve shown in FIG. 6, two variable stops 36, instead of only one variable stop, are formed opposite each other on the ring body 38. The two counter-stops 38 are also formed opposite each other. In this case, one of the two variable stops 36 interacts with one of the two counter-stops 37. Otherwise, the second variant is designed as described above. This description is therefore transferable to the second variant.

In further alternatives of the shut-off device, even more variable stops 36 and/or counter-stops 37 may be formed, which can interact with each other in exactly the same way as described here, for example.

### LIST OF REFERENCE SIGNS

1 Shut-off device, valve

2 Manual operating element

3 Closure element, main closure element

4 Seat, main valve seat

5 Control element

6 Distal end

7 Compensating device

8 Receptacle

9 Plunger

10 Return element

11 Proximal end

12 Longitudinal axis

14 Pressure chamber

15 Filling opening

16 Inlet

17 Cleaning pin

18 Outlet opening

19 Outlet

20 Second closure element, pilot closure element

21 Second valve seat, pilot valve seat

22 Seal

23a Housing part

23b Housing part

23c Housing part

24 Main body

25 Diaphragm

26 Passage opening

27 Manual operating element return spring

28 Interior of the manual operating element

29 First sleeve

30 Second sleeve

31 Guide elements

32 Actuating mechanism

33 Adjustment device

34 Control cam, sawtooth profile

35 Shoulders, pins

36 Variable stop

37 Counter-stop

38 Ring body

39 Toothing

40 Invariable stop

41 Second counter-stop

1. A shut-off device (1) for a flowable medium, the shut-off device comprising:
at least one closure element (3) that is movable into an open position and into a closed position, wherein in the open position a flow rate of the flowable medium through the shut-off device (1) is adjustable;
at least one variable stop (36); and
at least one counter-stop (37), the at least one variable stop (36) cooperates with the at least one counter-stop (37), and wherein using the at least one variable stop (36) and the at least one counter-stop (37) the flow rate that is adjustable in the open position is adapted to be limited to a variable subset.

2. The shut-off device (1) according to claim 1 wherein the at least one variable stop (36) comprises at least one variably arrangeable stop (36).

3. The shut-off device (1) according to claim 1, wherein the closure element (3) is adapted to be arranged in the open position in a plurality of opening positions, wherein each said opening position defines a predetermined flow rate of the flowable medium through the shut-off device (1), and the at least one variable stop (36) and the at least one counter-stop (37) ae configured to limit the plurality of opening positions to a variable subset of this plurality of opening positions.

4. The shut-off device (1) according to claim 1, wherein the at least one variable stop (36) is adapted to be variably arranged in relation to a maximum opening position, which defines a maximum flow rate of the flowable medium through the shut-off device (1), and/or in relation to a minimum opening position, which defines a minimum flow rate of the flowable medium through the shut-off device (1).

5. The shut-off device (1) according to claim 1, wherein the closure element (3) is adapted to be arranged in the open position in a stop position that is coupled to an arrangement of the at least one variable stop (36).

6. The shut-off device (1) according to claim 1, wherein the at least one closure element (3) is a closure element (3) that is switchable discretely between the open position and the closed position.

7. The shut-off device (1) according to claim 6, further comprising a bistable actuating mechanism (32) with which the at least one closure element (3) is switchable.

8. The shut-off device (1) according to claim 1, further comprising an adjustment device (33) with which the at least one closure element (3) is arrangeable in a plurality of opening positions.

9. The shut-off device (1) according to claim 8, wherein the at least one variable stop (36) or the at least one counter-stop (37) is arrangeable on a movable component of the adjustment device (33).

10. The shut-off device (1) according to claim 8, wherein the adjustment device (33) comprises a mechanism with an actuator (29), and the at least one variable stop (36) is adapted to be variably arranged on the actuator (29).

11. The shut-off device (1) according to claim 10, wherein the adjustment device (33) comprises a combination of a control cam (34) and a plurality of shoulders (35) sliding along the control cam (34).

12. The shut-off device (1) according to claim 11, wherein the actuator (29) has a plurality of guide elements (31) for receiving a cover cap, said guide elements extend transversely to a direction of movement, and the at least one variable stop (36) is arranged on one or more of the guide elements (31).

13. The shut-off device (1) according to claim 11, wherein the mechanism with the actuator (29) is a rotary mechanism, and said guide elements extend transversely to a direction of rotation or a plane of rotation of the rotary mechanism.

14. The shut-off device (1) according to claim 10, wherein at least one of the actuating mechanism (32) or the adjustment device (33) has a push-push locking mechanism.

15. The shut-off device (1) according to claim 1, wherein the at least one variable stop (36) is formed on a ring body (38).

16. The shut-off device (1) according to claim 15, wherein the ring body (38) has a toothing (39).

17. The shut-off device (1) according to claim 1, wherein the at least one variable stop includes two of the variable stops (36) and the at least one counter-stop includes two of the counter-stops (37) that cooperate with the two of the variable stops (36), and the flow rate adjustable in the open position is adapted to be limited to a variable subset by the two stops (36) and the two counter-stops (37).

18. The shut-off device (1) according to claim 17, wherein the two of the variable stops (36) are two variably arrangeable stops (36).

19. The shut-off device (1) according to claim 1, further comprising an invariable stop (40) and a counter-stop of second type (41) cooperating therewith, wherein an interaction of the invariable stop (40) and the counter-stop of second type (41) limits the flow rate that is adjustable in the open position.

20. The shut-off device (1) according to claim 1, wherein the shut-off device (1) is a diaphragm valve with flow adjustment.
